(19) United States
(12) Patent Application Publication
(10) Pub. No.: US 2010/0013920 A1
(43) Pub. Date: Jan. 21, 2010

(54) SURVEILLANCE IMAGING WITH UPSAMPLING

(75) Inventors: Serge L. NIKULIN, San Jose, CA (US); Rasmus M. LARSEN, San Francisco, CA (US)

Correspondence Address: KOLISCH HARTWELL, P.C., 200 PACIFIC BUILDING, 520 SW YAMHILL STREET, PORTLAND, OR, 97204, US

(73) Assignee: SAFEVIEW, INC., Santa Clara, CA (US)

(21) Appl. No.: 12/176,869

(22) Filed: Jul. 21, 2008

(51) Int. Cl. H04N 7/18

(52) U.S. Cl. 348/143; 348/E07.085

(57) ABSTRACT

Surveilling a subject may include irradiating a portion of the subject with electromagnetic radiation, receiving radiation reflected from the subject, and producing digital image data representative of an image of the portion of the subject. The digital image data may be used as input for computations including image processing and/or analysis, and the result of such processing and/or analysis may be used to make determinations about the subject, such as whether subject is carrying contraband. In some embodiments, the digital image data may be upsampled into expanded digital image data, which may improve the quality and/or effectiveness of downstream image processing and/or analysis.

### BACKGROUND OF THE DISCLOSURE

Millimeter wave signals are used for radar and telecommunications. They are also capable of being used to produce data representative of a subject, by directing millimeter-wave signals at the subject and detecting the reflected signal. The data produced may then be used to produce an image of the subject. Examples of such imaging systems are described in U.S. Pat. Nos. 5,455,590; 5,557,283; 5,859,609; 6,507,309; 6,703,964; 6,876,322; 7,123,185; 7,202,808; 7,365,672; and 7,386,150, and U.S. Patent Publication Numbers 2004/0090359 and 2006/0104480, which patent references are incorporated herein by reference.

When imaging systems are used for surveillance of persons, it may be desirable for the system to quickly, conveniently and safely perform the surveillance. This is particularly true in situations where the surveillance delays the intended progress of the person being surveilled, such as prior to boarding a public transportation vehicle, or prior to entering a public or protected facility. Accordingly, imaging systems and/or methods that are effective in producing increased surveillance information may provide improved throughput of surveilled people and other subjects.

### BRIEF SUMMARY OF THE DISCLOSURE

In some examples, a method of surveilling a subject may include irradiating from a first antenna unit spaced from the subject at least a portion of the subject with electromagnetic radiation in a frequency range between about 100 MHz and about 2 THz; receiving the irradiated radiation reflected from the subject, and producing, from the received radiation, digital image data representative of at least a first image of at least the portion of the subject based at least in part on reflectivity of the radiation received. The digital image data may be upsampled for improved image processing and/or analysis by replacing each image element within the digital image data with N image elements.

### BRIEF DESCRIPTION OF THE DRAWINGS

FIG. 1 is a general diagram showing a surveillance imaging system.

FIG. 2 is a general diagram showing an example of an imaging system according to FIG. 1.

FIG. 3 is a flowchart showing an example of a method of surveilling a subject including upsampling digital image data prior to image processing or analysis.

FIG. 4 shows an example of a two-dimensional digital image being upsampled into a second expanded digital image.

FIG. 5 shows an example of a three-dimensional digital image being upsampled into a second expanded digital image.

FIG. 6 is a flowchart showing an example of a surveillance and image analysis methodology.

FIG. 7 is a flowchart showing an example of how the upsampling of digital image data may be incorporated into an overall surveillance and image analysis methodology similar to that shown in FIG. 6.

FIG. 8 shows an example of an image of a whole subject produced without upsampling.

FIG. 9 shows an example of an image of the same subject shown in FIG. 8, except that upsampling has been applied.

FIG. 10 shows an example of an image of a portion of a subject produced without upsampling.

FIG. 11 shows an example of an image of the same portion of the subject shown in FIG. 10, except that upsampling has been applied.

### DETAILED DESCRIPTION OF VARIOUS EMBODIMENTS

This description is illustrative and directed to the apparatus and methods described, and may describe multiple embodiments. The claims that are appended to this description, whether now or later in this or a subsequent application, define specific inventions included in the described apparatus and or methods. No single feature or element, or combination thereof, is essential to all possible combinations that may now or later be claimed. While examples of apparatus and methods are particularly shown and described, many variations may be made therein. Such variations may be directed to the same combinations and/or to different combinations, and may be different, broader, narrower or equal in scope. An appreciation of the availability, scope or significance of various embodiments may not be presently realized. Thus, any given embodiment disclosed by example in this disclosure does not necessarily encompass all or any particular features, characteristics or combinations, except as specifically claimed.

Where “a” or “a first” element or the equivalent thereof is recited, such usage includes one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically indicated.

There are situations in which it is desirable to identify features of a subject, particularly features of a person and any objects carried by the person. For example, it may be desired to determine whether the subject includes objects not apparent from a visual inspection of the subject. For example, when monitoring people prior to entry into a controlled-access environment, such as a public, private or government facility, building or vehicle, the accuracy of observation may be benefited by employing millimeter-wave imaging technology. Regardless of the application, the benefits derived from the monitoring may depend on the speed and accuracy of the monitoring, and where appropriate, the effectiveness of identifying visually hidden objects. The imaging of the location of parts of the person's body, such as the head, one or both legs, a privacy sensitive area, or other features, may assist in processing images of a subject, such as identifying objects.

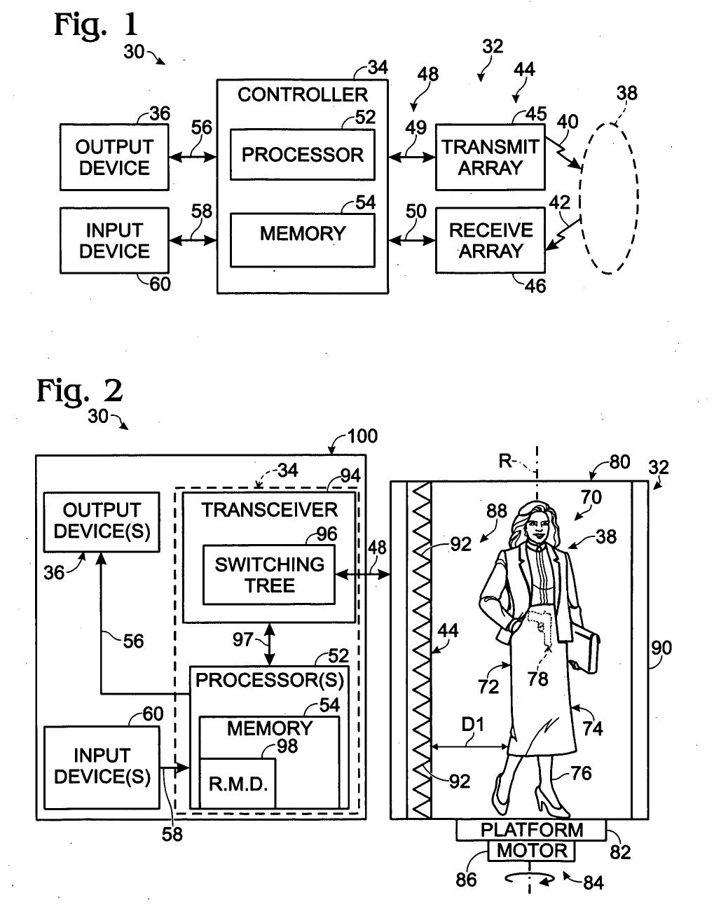

Shown generally at 30 in FIG. 1 is an exemplary imaging system. System 30 may include an interrogating apparatus 32, a controller 34, and in some systems, an output device 36. The system may interrogate a subject 38 in the sense that the interrogating apparatus 32 transmits electromagnetic radiation 40 toward the subject, and in response, the subject emits or reflects electromagnetic radiation 42 that is detected by interrogating apparatus 32.

Subject 38 may include all that is presented for interrogation by an interrogation or imaging system, whether human, animal, or an inanimate object. For example, if a person is presented for interrogation, subject 38 may include the entire person's body or a specific portion or portions of the person's body. Optionally, subject 38 may include one or more persons, animals, objects, or a combination of these.

System 30 may be adapted to interrogate subject 38, through interrogating apparatus 32, by irradiating it with electromagnetic radiation, and detecting the reflected radiation. Electromagnetic radiation may be selected from an appropriate frequency range, such as in the range of about 100 megahertz (MHz) to 2 terahertz (THz), which range may be generally referred to herein as millimeter-wave radiation. Accordingly, imaging, or the production of digital images from the detected radiation, may be obtained using electromagnetic radiation in the frequency range of one gigahertz (GHz) to about 300 GHz. Radiation in the range of about 5 GHz to about 110 GHz may also be used to produce acceptable images. Some imaging systems use radiation in the range of 24 GHz to 30 GHz. Such radiation may be either at a fixed frequency or over a range or set of frequencies using one or more of several modulation types, e.g. chirp, pseudorandom frequency hop, pulsed, frequency modulated continuous wave (FMCW), or continuous wave (CW).

Certain natural and synthetic fibers may be transparent or semi-transparent to radiation of such frequencies and wavelengths, permitting the detection and/or imaging of surfaces positioned beneath such materials. For example, when the subject of interrogation is an individual having portions of the body covered by clothing or other covering materials, information about portions of the subject's body covered by such materials can be obtained with system 30, as well as those portions that are not covered. Further, information relative to objects carried or supported by, or otherwise with a person beneath clothing can be provided with system 30 for metal and non-metal object compositions.

Many variations of interrogating apparatus 32 are possible. For example, interrogating apparatus 32 may include one or more antenna arrays 44, such as a transmit array 45 of one or more antenna units, each of which may further include a single antenna that transmits radiation 40 or a plurality of antennae that collectively transmit radiation. A receive array 46 may receive radiation 42 reflected from subject 38. Optionally, some embodiments may employ one or more antennae apparatus as described in U.S. Pat. No. 6,992,616 B2 issued Jan. 31, 2006, entitled “Millimeter-Wave Active Imaging System”, the disclosure of which is incorporated herein by reference. Optionally, each antenna unit may both transmit and receive radiation.

Depending on the interrogating apparatus, an imaging system may include an apparatus moving mechanism, not shown, that may move interrogating apparatus 32 relative to a subject 38, for scanning subject 38 with one or more transmit and/or receive arrays. Such a moving mechanism may move subject 38 relative to a work surface, such as a floor, may move interrogating apparatus 32 relative to the work surface, or may move both subject 38 and interrogating apparatus 32 relative to the work surface. Further, motion may be vertical, horizontal, or a combination of vertical and horizontal.

Interrogating apparatus 32 may be coupled to controller 34. As contemplated herein, controller 34 may include structure and functions appropriate for generating, routing, processing, transmitting to interrogating apparatus 32 and receiving from interrogating apparatus 32 millimeter-wave signals. Controller 34, in this comprehensive sense, may include multiplexed switching among individual components of interrogating apparatus 32, transmit electronics, receive electronics, and mechanical, optical, electronic, and logic units. Controller 34 thus may send to and receive from interrogating apparatus 32 signals 48, such as transmit-related signal 49 and receive-related signal 50, respectively. Signal 48 may include appropriate signals, such as control signals and image-related signals.

Controller 34 may include hardware, software, firmware, or a combination of these, and may be included in a computer, computer server, or other microprocessor-based system capable of performing a sequence of logic operations. In addition, processing may be distributed with individual portions being implemented in separate system components.

Accordingly, controller 34 may include a processor 52 and a memory 54. Controller components such as output devices, processors, memories and memory devices, and other components, may be wholly or partly co-resident in interrogating apparatus 32 or be wholly or partly located remotely from the interrogation apparatus.

Processor 52 may process data signals received from interrogating apparatus 32. Processor 52 thus may include hardware, software, firmware, or a combination of these, and may be included in a computer, computer server, or microprocessor-based system capable of performing a sequence of logic operations. Processor 52 may be any analog or digital computational device, or combination of devices, such as a computer(s), microprocessor(s), or other logic unit(s) adapted to control interrogating a subject and receiving signals 50, and to produce, process, and/or otherwise manipulate digital image data 56 representative of at least a portion of the subject interrogated.

A program or programs embodying the disclosed methods need not reside in a single memory or other storage medium, or even a single machine. Various portions, modules or features of them can reside in separate memories, or even separate machines. The separate machines may be connected directly, or through a network, such as a local access network (LAN), or a global network, such as what is presently generally known as the Internet. Similarly, the machines need not be co-located with each other.

Digital image data may include any data or data sets, whether processed, partially processed or unprocessed, or sub-sets of the data, such as: data for a portion of a subject; data that is manipulated in order to identify information corresponding to one or more given features of a subject; data that is manipulated in order to present, for viewing by an operator or by another processor, information corresponding to a subject and/or one or more given features of a subject; or measurements or other information relating to a subject that is derived from received signals. Digital image data may be output via signal 56 to one or more output devices 36 coupled to processor 52, such as a storage medium or device, communication link, such as a network hub, another computer or server, a printer, or directly to a display device, such as a video monitor. Processor 52 may also be coupled to receive input signals 58 from an input device 60, such as a keyboard, cursor controller, touch-screen display, another processor, a network, or other device, communication link, such as a source of information for operating the system or supplemental information relating to a given subject.

In some embodiments, processor 52 may be coupled to memory 54 for storing data, such as one or more data sets produced by processor 52, or operating instructions, such as instructions for processing data. Memory 54, referred to generally as storage media, may be a single device or a combination of devices, and may be local to the processor or remote from it and accessible on a communication link or network. Operating instructions or code may be stored in memory 54, along with digital image data, and may be embodied as hardware, firmware, or software.

Data produced or accessed by processor 52 may thus be sent for storage to and retrieved from memory 54. In some examples, data produced from interrogating a given subject or input from another source may be retrieved for further computations including image processing and/or analysis, which will be described further below.

In some examples, data produced from interrogating subject 38 may be expanded, or as referred to herein more generally, upsampled, so that image processing and/or analysis may be performed on the upsampled data to achieve more reliable or otherwise improved results than would be obtained using non-upsampled data. Upsampling data may include replacing each individual image element (e.g., pixel, voxel) in a set of digital image data with N image elements having the same value to form second expanded digital image data.

Using upsampling with the above and below-described apparatus, a method of surveilling a subject may comprise the steps of interrogating the subject with electromagnetic radiation in a frequency range of about 100 MHz to about 2 THz; generating, from the interrogating, first digital image data comprising a first D-dimensional array of image elements, where D is an integer, each image element having a respective first value, the first digital image data being representative of at least a first image of at least a portion of the subject; replacing each image element with a set of N image elements each having a same second value to form a second Dimensional array containing expanded second digital image data, where N is an integer; performing a computation using the expanded second digital image data as input; and storing a result of the computation in memory. These steps will be more fully understood in view of the following description.

A second example of an imaging system 30 is illustrated in FIG. 2. In imaging system 30, a subject 38 in a subject position 70 may include a person 72 presented for interrogation by system 30. Person 72 is shown wearing clothing 74 over her or his body 76, which clothing conceals an object 78, shown in the form of a weapon. Subject 38 may be positioned in an interrogation station or portal 80 of imaging system 30. Portal 80 may be configured in various ways for placement at a security checkpoint where it is desired to detect objects, such as weapons or contraband, on a person or other subject. Portal 80 may include, for example, a platform 82 connected to a motion mechanism 84 in the form of motor 86. Platform 82 may be arranged to support subject 38. Motor 86 may be arranged to rotate selectively the platform about a subject axis R while subject 38 is positioned thereon. For the configuration shown, axis R may be vertical, and subject 38 may be in a generally central subject position 70 relative to axis R and platform 82. Optionally, motor 86 may rotate portal 80 around subject position 70, which subject position remains fixed relative to a work surface, such as a floor on which the portal is positioned.

Interrogating apparatus 32 may include one or more antenna apparatus, such as an antenna apparatus 88 including a primary multiple-element sensing array 44. The interrogating apparatus 32 may include a frame 90 on which array 44 is supported. Array 44 may extend the full height of frame 90. Motor 86 may cause platform 82, and subject 38 to rotate about axis R. As a result, array 44 circumscribes a generally circular pathway around the subject position about axis R. Other paths of movement may also be used. The antenna array may be positioned relative to the subject as is appropriate. In some examples, the antenna array is about 0.5 to about 2 meters from the subject position.

In this example, antenna array 44 may include a number of regularly spaced, linearly arranged antenna units 92 only a few of which are schematically illustrated. Each unit 92 may include one or more antenna elements dedicated to transmission or reception of radiation or both. An antenna unit may then correspond to a single antenna element if the element both transmits and receives, or two adjacent elements with one transmitting and the other receiving. Correspondingly, the position of an antenna unit is the position of the associated antenna element or elements. In one example, the elements may be arranged in two generally vertical columns, with one column dedicated to transmission, and the other to reception. The number and spacing of the elements corresponds to the wavelengths used and the resolution desired. A range of 200 to about 600 elements can span a vertical length of about two or two and one-half meters, with the elements spaced less than two wavelengths of a design wavelength apart. For example, U.S. Pat. No. 5,455,590 discloses a configuration in which the rows of transmit and receive antenna elements are spaced 1.5 wavelengths apart, and the antenna elements within in each row of transmit or receive elements are spaced 1.33 wavelengths apart. The in-line spacing between transmit and receive antenna elements, which determines the resolution of the image, is less than one wavelength. In the '590 patent, a spacing of ½ wavelength to ¾ wavelength is suggested.

Various other configurations for portal 80 and interrogating apparatus 32 may be used. For example, a two-dimensional transmit and receive array may be used, as well as an array that moves around a fixed subject platform, or an array that moves vertically and extends horizontally. Accordingly, the positions the antenna units are in during physical or electronic scanning are referred to generally as antenna-unit positions. Further, many variations of an antenna apparatus are possible. The antenna apparatus may include one or more antenna units, and each antenna unit may include one or more transmitting antenna elements and/or one or more receiving antenna elements. An antenna unit may include a plurality of antenna elements that may receive radiation in response to transmission by a single antenna element. The antenna elements may be any appropriate type configured to transmit or receive electromagnetic radiation, such as a slot line, patch, endfire, waveguide, dipole, semiconductor, or laser. Antenna elements may both transmit and receive. The antenna units may have one or more individual antenna elements that transmit or receive like polarization or unlike polarized waveforms, such as plane, elliptical, or circular polarization, and may have narrow or broad angular radiation beam patterns, depending on the application. Beam width may be relatively broad, i.e. 30 to 120 degrees for imaging applications that use holographic techniques, while narrow beam widths in the range of 0 to 30 degrees may be used for applications having a narrow field of view requirement.

Further, a single antenna may scan a subject by mechanically moving about the subject in a one- or two-dimensional path. A one- or two-dimensional array of antenna units may electronically and mechanically scan a subject. An interrogating apparatus may include one or a plurality of transmit and/or receive antenna apparatus. The antenna apparatus may be protected from the environment by suitable radome material, which may be part of the apparatus, or separate, depending on the mechanical motion that is required of the antenna apparatus or array. Examples of other array configurations are illustrated in U.S. Pat. No. 6,992,616 B2, which is incorporated herein by reference.

A controller 34 may control operation of interrogating apparatus 32. Controller 34 may include a transceiver 94 including a switching tree 96 configured to irradiate subject 38 with only one transmitting element at a time, and simultaneously receive with one or more elements. Transceiver 94 may include logic to direct successive activation of each combination of transmit and receive antenna elements to provide a scan of a portion of a subject 38 along a vertical direction as platform 82 and the subject rotate. Other configurations of transceiver 94 may be used. For example, the transceiver may include structurally and/or electrically separate transmitter(s) and receiver(s).

An image signal 50 received from array 44 may be downshifted in frequency and converted into an appropriate format for processing. In one form, transceiver 94 may be of a close-spaced bi-static (referred to herein as pseudo-monostatic) heterodyne Frequency Modulated Continuous Wave (FM/CW) type like that described in U.S. Pat. No. 5,859,609. Other examples are described in U.S. Pat. Nos. 5,557,283 and 5,455,590. In other embodiments, a mixture of different transceiver and sensing element configurations with overlapping or non-overlapping frequency ranges may be utilized, and may include one or more of the impulse type, monostable homodyne type, bi-static heterodyne type, and/or other appropriate type.

Transceiver 94 may provide image data 97 corresponding to the image signals to one or more processors 52. Processor 52 may include any suitable component for processing the digital image data, as appropriate. Processor 52 may be coupled to a memory 54 of an appropriate type and number. Memory 54 may include a removable memory device (R.M.D.) 98, such as a tape cartridge, floppy disk, CD-ROM, or the like, as well as other types of memory devices, all generally referred to as storage media.

Controller 34 may be coupled to motor 86 or other drive element used to control selectively the rotation of platform 82 or antenna apparatus 88. Controller 34 may be housed in a monitor and control station 100 that may also include one or more input devices 60, such as operator or network input devices, and one or more displays or other output devices 36.

Memory 54 may contain instructions adapted to be executed by processor 52 to perform one or more computations using digital image data as input, and store a result of the computations in memory such as memory 54. Computations may include but are not limited to image processing and image analysis.

“Image processing” as used herein can mean a computation using digital image data as input that either modifies the existing input data, or creates a new modified copy of the input data. Image processing may include but is not limited to image enhancement, producing an image of a subject or portion of a subject derived from received signals (i.e. image reconstruction), sharpening, applying a threshold, or other similar processes meant to act upon digital image data. The result of image processing may be used for display, as input for further image processing, for input for image analysis, and/or may be stored in memory.

“Image analysis” as used herein can mean a computation using digital image data as input that provides as output an indication of a characteristic of the digital image data or the subject represented by the digital image data, such as identifying information corresponding to a feature of the subject. Examples of image analysis include but are not limited to the detection of objects on or portions of the subject, as is described in U.S. Pat. No. 7,386,150, issued Jun. 10, 2008, entitled “Active subject imaging with body identification,” as well as the concealment of areas of subject 38 to address privacy concerns, as described in U.S. Pat. No. 7,202,808, issued Apr. 4, 2007, entitled “Surveilled subject privacy imaging,” both patents which are incorporated herein by reference.

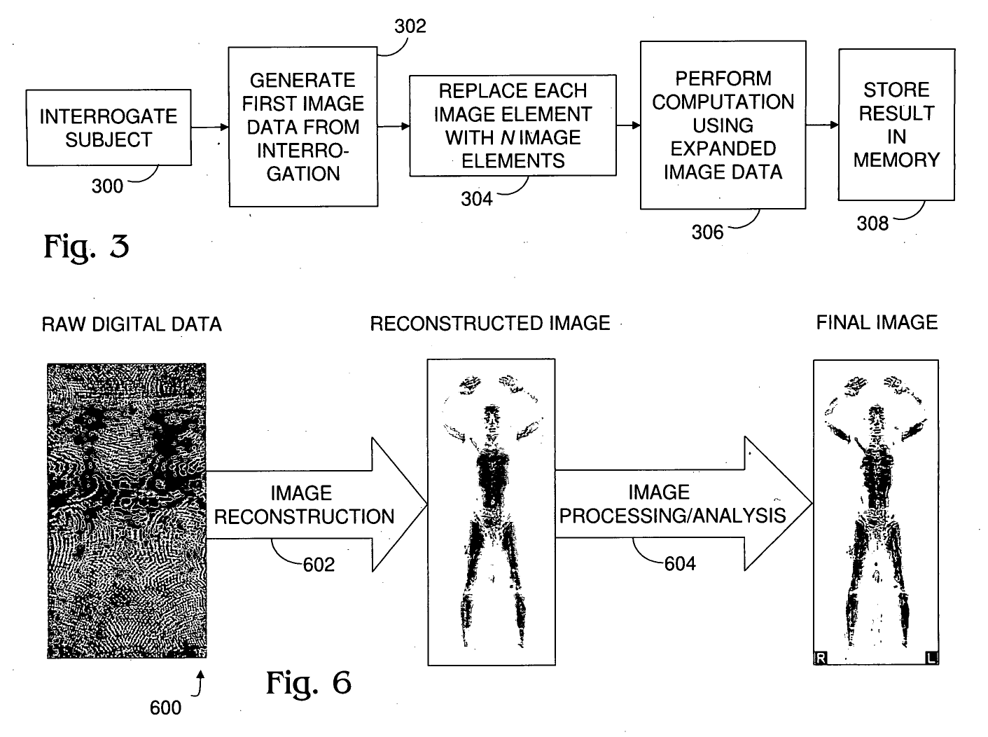

Digital image data may be used as input in an upsampling process (hereafter referred to as “upsampled”) to improve downstream image processing and/or analysis. The term “upsampling” is used herein to refer to a process of expanding digital image data to expanded digital image data. The expanded digital image data is representative of the same image as the original digital image data. However, the expanded digital image data contains more image elements such as pixels or voxels. The process of upsampling, as described herein, will be better understood in view of FIGS. 3-11 and the following discussion.

It has been observed that upsampling digital image data at a point upstream from image processing and/or analysis enhances the accuracy and/or effectiveness of downstream image processing and analysis. One possible reason is that the more pixels contained in a set of digital image data, the more relationships between pixels there are to process and/or analyze.

As illustrated in FIG. 3, controller 34 may be configured to interrogate subject 38 with electromagnetic radiation in a frequency range of about 100 MHz to about 2 THz in step 300. In step 302, processor 52 may generate, from the interrogation, first digital image data comprising a first D-dimensional array of image elements, where D is an integer, each image element having a respective first value, the first digital image data being representative of at least a first image of at least a portion of subject 38.

Processor 52 may then in step 304 upsample the first digital image data. Upsampling includes replacing each image element with a set of N image elements each having a same second value to form a second D-dimensional array containing expanded second digital image data, where N is an integer.

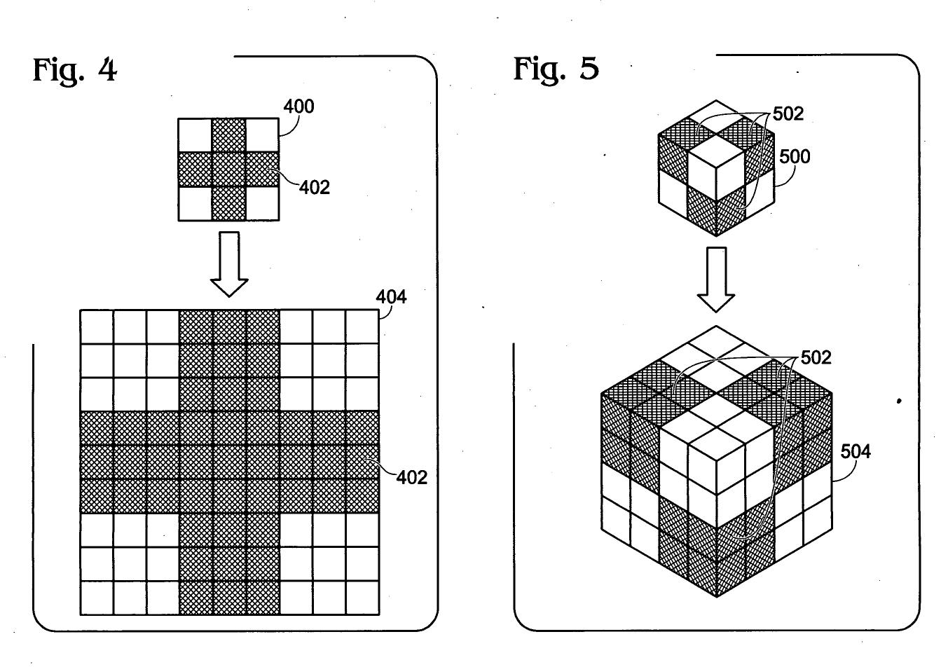

FIG. 4 depicts a simple example of how two-dimensional digital image data may be upsampled in accordance with step 304. Digital image data 400 comprises a three-by-three array of image elements containing information relating to at least a portion of a subject. Because digital image data 400 is two-dimensional, each image element may be referred to as a “pixel.” Each image element, or pixel, may contain one or more values. For example, each pixel may contain one or more values corresponding to one or more intensity levels and/or colors to be displayed at the pixel's respective location on output device 36.

For illustrative purposes, a simple object 402 resembling a plus sign is depicted in image 400. A set of expanded digital image data 404 that has been upsampled from digital image data 400 is shown below digital image data 400. Each pixel in digital image data 400 has been replaced during the upsampling process with a three-by-three array of N=9 pixels. In this example, each of the N pixels has the same value as the original pixel. Accordingly, the expanded second digital data 404 is representative of the same first image 402 as first data 400, except that second digital data 404 contains more pixels.

The example of FIG. 4 is not meant to be limiting. For example, while the pixels of digital image data 400 appear to either be on or off, it should be understood that digital image data 400 is intended for illustrative purposes only, and each image element in a given set of digital image data may be capable of containing varying values, as described above. Moreover, while in this example, replacing each image element with N=9 image elements means replacing each pixel with an array of n=3 pixels in D=2 dimensions (where N=n^{D}), it should be understood that a pixel may be replaced with more or less pixels in one dimension than another. Furthermore, expanded two-dimensional data is not limited to replacing a pixel with N=9 pixels. Other numbers of replacement pixels, such as N=4, N=16 or even higher, are contemplated herein.

In some examples, such as the one shown in FIG. 4, the second value of each of the set of N image elements replacing each image element in the first array is equal to the respective first value of the image element the set of N image elements replaces. For example, the top left pixel of digital image data 400 is off. Accordingly, the top left 9 pixels of expanded second digital data 404, which replaced the top left pixel of digital image data 400, are also off.

As noted above, one purpose for upsampling is to improve downstream image processing and/or analysis. Referring back to FIG. 3, in step 306, processor 52 performs a computation using the expanded second digital image data (e.g., 404) as input. The performed computation may be one or more of many types of image processing and/or analysis, some of which are mentioned above. In step 308, processor 52 stores a result of the computation in memory 54.

While the expansion of digital image data described in relation to FIG. 4 was performed on two-dimensional data, expansion of three-dimensional digital image data also is contemplated using the method of FIG. 3. FIG. 5 depicts an example of three-dimensional digital image data 500 being upsampled in accordance with step 304. Because digital image data 500 is three-dimensional, each image element may be referred to as a “voxel.” Digital image data 500 comprises a 2×2×2 array of image elements, or voxels, containing information relating to at least a portion of a subject 38. A pattern 502 of voxels that are “on” is seen in digital image data 500.

Below digital image data 500 is expanded digital image data 504. As before, digital image data 504 is representative of the same image as digital image data 500, except that expanded digital image data 504 contains more voxels. In this case, each voxel of digital image data 500 was replaced with N=8 voxels to obtain expanded digital image data 504, which is a 4×4×4 array of 64 voxels.

FIG. 5 is not meant to be limiting. For example, while the voxels of digital image data 500 appear to either be on or off, it should be understood that digital image data 500 is intended for illustrative purposes only, and each voxel in a given set of digital image data may contain various values, such as various values corresponding to one or more intensity levels and/or colors. Moreover, while in this example, replacing each voxel with N=8 voxels means replacing each voxel with an array of n=2 voxels in D=3 dimensions (where N=n^{D}), it should be understood that a voxel may be replaced with more or less voxels in one dimension than another. Expanded three-dimensional data is not limited to replacing a voxel with N=8 voxels. Other numbers of replacement voxels, such as N=27, N=64 or even higher, are contemplated herein.

Most of the graphical images included in the following figures are shown in a reverse image in order to produce lighter images. Lighter images tend to be more readily reproduced using such duplicating equipment as printers, copiers and scanners. Thus, although images in which subjects are shown with lighter, and therefore brighter, intensities may be more readily and realistically perceived, it will be appreciated that the methods disclosed and discussed apply to either form of representation, or to any representation or valuation of data or characteristic that provides a distinction, whether or not suitable for display.

FIG. 6 is a flowchart showing a process 600 of preparing digital image data for and performing image processing and/or analysis on digital image data without upsampling. Raw digital image data may be obtained from an interrogation apparatus such as the one described above. For example, received signal 50 may be an analog signal, and the raw digital image data may be obtained by sampling the analog data in an analog-to-digital converter to produce a corresponding digital signal.

In step 602, the raw digital image data is converted into a human-viewable image using an image reconstruction algorithm such as those described in U.S. Pat. Nos. 5,557,283 and 5,859,609. These methods may include one or more of the steps of: computing a two-dimensional Fourier transform of the digital image data; multiplying the two-dimensional Fourier transform by a complex backward wave propagator and forming a backward wave product; interpolating the backward wave product onto a uniformly sampled grid and forming an interpolated product; computing a three-dimensional inverse transform of the interpolated product and obtaining a complex three-dimensional image; and computing a magnitude of the complex three-dimensional image and obtaining a three-dimensional image.

Once the digital image data has undergone the reconstruction process, in step 604, one or more image processing and/or analysis computations are performed using the reconstructed digital image data as input. In addition to the examples mentioned above, examples of image processing and/or analysis include applying a transformation kernel, dilating dark features, eroding light features, generating a range or variance in depth in a region around each image element, combining two or more different processed images into a composite image, smoothing, application of Gaussian filters, and the like. The output final image is shown on the right.

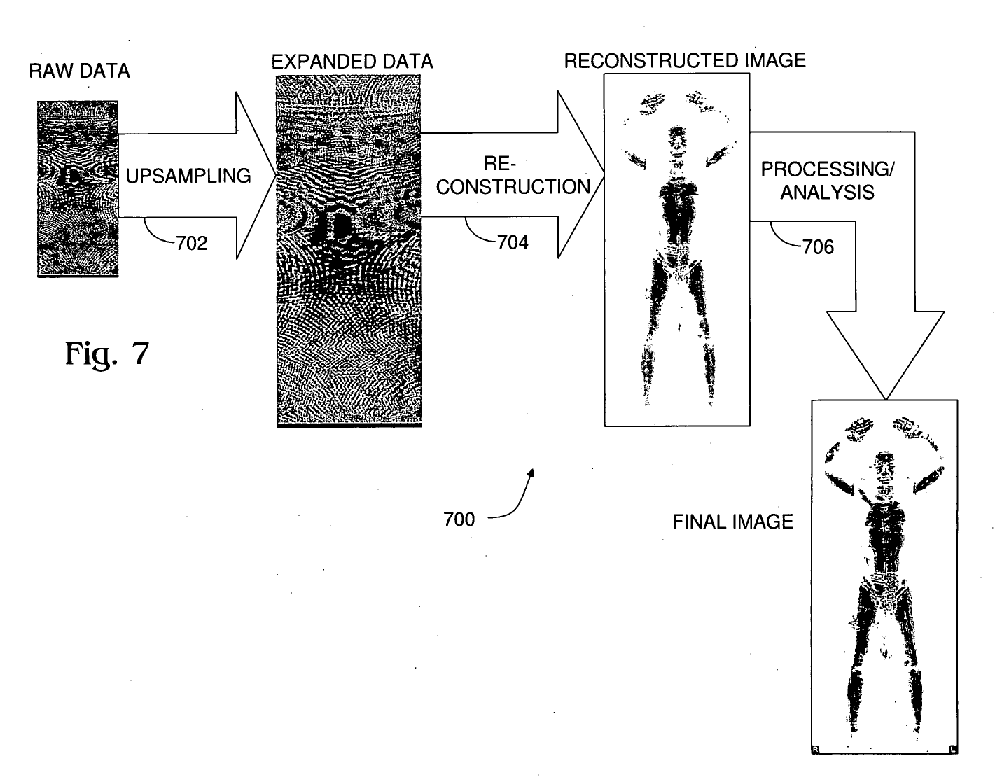

FIG. 7 depicts an example process 700 similar to process 600, except that upsampling is used to improve image processing and analysis. In step 702, which is similar to step 304 of FIG. 3, raw digital image data (obtained using similar methods as the process 600 of FIG. 6) is upsampled to obtain expanded digital image data. In step 704 the expanded digital image data is converted into a human-readable image as in step 602 of FIG. 6. In step 706, similar to step 306 of FIG. 3, one or more image processing and/or analysis computations, such as those described above, are performed using the reconstructed digital image data as input. The output final image is seen in the bottom right.

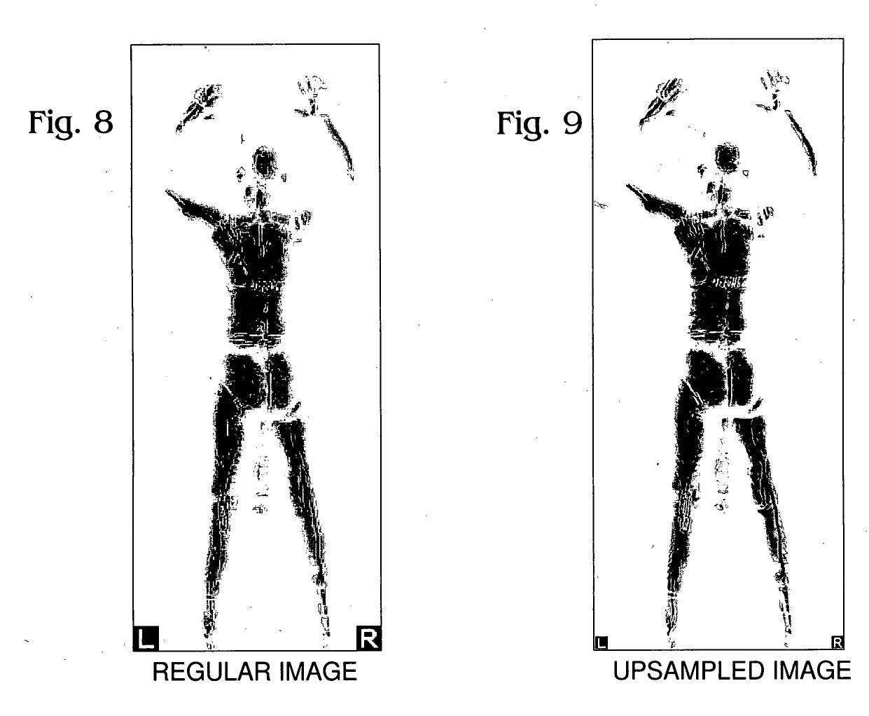

FIGS. 8 and 9 depict processed images showing a whole subject 38. The digital image data depicted in FIG. 8 was processed according to process 600 and was not upsampled prior to image processing and/or analysis. FIG. 9 depicts the same subject 38 as FIG. 8 except that the digital image data in FIG. 9 was processed according to process 700, including upsampling prior to image processing and/or analysis. As can be seen, the image of FIG. 9 is clearer than the image of FIG. 8. This clarity provides for improved image processing and/or analysis.

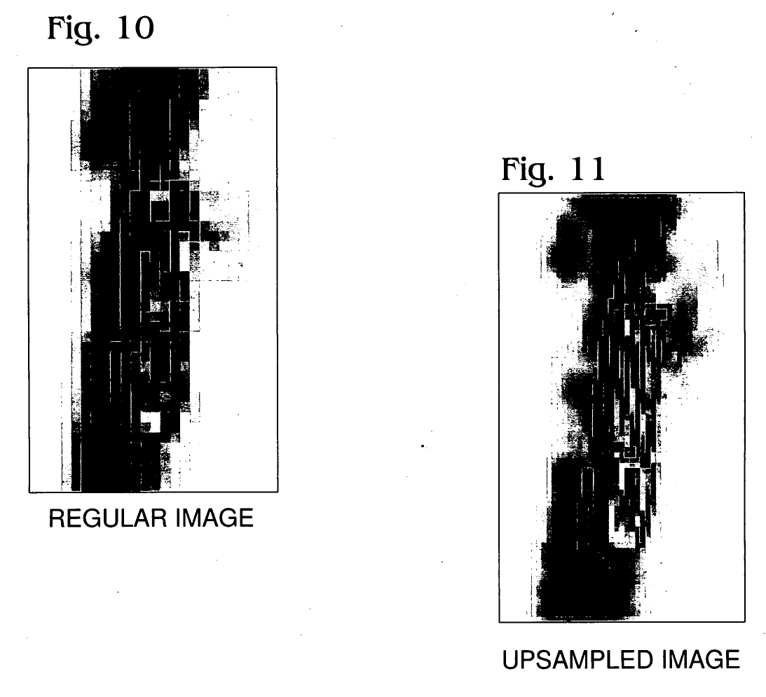

FIGS. 10 and 11 depict close-up views of the back of a left knee of subject 38 shown in FIGS. 8 and 9, respectively. The digital image data in FIG. 10 was not upsampled prior to image processing analysis. FIG. 11 was upsampled. While it is not clear in FIG. 10 that there is any sort of object on the back of the knee, FIG. 11 more clearly shows a knife hidden behind the knee. Narrow objects such as knives or other weapons may be more discernable when the underlying digital image data has been upsampled.

### INDUSTRIAL APPLICABILITY

The methods and apparatus described in the present disclosure are applicable to security, monitoring and other industries in which surveillance and imaging systems are utilized.

What is claimed is:

1. A method of surveilling a subject comprising:
interrogating the subject with electromagnetic radiation in a frequency range of about 100 MHz to about 2 THz;
generating, from the interrogating, first digital image data comprising a first D-dimensional array of image elements, where D is an integer, each image element having a respective first value, the first digital image data being representative of at least a first image of at least a portion of the subject;
replacing each image element with a set of N image elements each having a same second value to form a second D-dimensional array containing expanded second digital image data, where N is an integer;
performing a computation using the expanded second digital image data as input; and
storing a result of the computation in memory.

2. The method of claim 1 wherein the second value of each of the set of N image elements replacing each image element in the first D-dimensional array is equal to the respective first value of the image element the set of N image elements replaces.

3. The method of claim 1 wherein N=n^{D}, where n is an integer greater than 1, and replacing each image element includes replacing each image element with an array of n image elements in each dimension.

4. The method of claim 1 wherein D=2 and each image element is a pixel.

5. The method of claim 4 wherein N is at least 4.

6. The method of claim 4 wherein N is at least 9.

7. The method of claim 1 wherein D=3 and each image element is a voxel.

8. The method of claim 7 wherein N is at least 8.

9. The method of claim 7 wherein N is at least 27.

10. The method of claim 1 wherein performing a computation includes reconstructing a human-viewable image from the expanded second digital image data.

11. The method of claim 10 wherein reconstructing the human-viewable image comprises one or more of:
computing a two-dimensional Fourier transform of the expanded second digital image data;
multiplying the two-dimensional Fourier transform by a complex backward wave propagator and forming a backward wave product;
interpolating the backward wave product onto a uniformly sampled grid and forming an interpolated product;
computing a three-dimensional inverse transform of the interpolated product and obtaining a complex three-dimensional image; and
computing a magnitude of the complex three-dimensional image and obtaining a three-dimensional image.

12. An imaging system for surveilling a subject, the imaging system being configured to perform the steps of:
interrogating the subject with electromagnetic radiation in a frequency range of about 100 MHz to about 2 THz;
generating, from the interrogating, first digital image data comprising a first D-dimensional array of image elements, where D is an integer, each image element having a respective first value, the first digital image data being representative of at least a first image of at least a portion of the subject;
replacing each image element with a set of N image elements each having a same second value to form a second D-dimensional array containing expanded second digital image data, where N is an integer;
performing a computation using the expanded second digital image data as input; and
storing a result of the computation in memory.

13. The imaging system of claim 12 wherein the second value of each of the set of N image elements replacing each image element in the first D-dimensional array is equal to the respective first value of the image element the set of N image elements replaces.

14. The imaging system of claim 12 wherein N=n^{D}, where n is an integer greater than 1, and replacing each image element includes replacing each image element with an array of n image elements in each dimension.

15. The imaging system of claim 12 wherein D=2 and each image element is a pixel.

16. The imaging system of claim 15 wherein N is at least 4.

17. The imaging system of claim 12 wherein D=3 and each image element is a voxel.

18. The imaging system of claim 17 wherein N is at least 8.

19. The imaging system of claim 18 wherein performing a computation includes reconstructing a human-viewable image from the expanded second digital image data.

20. A storage medium, readable by a processor of a computer system, having embodied therein a first computer program of commands executable by the processor, the program being adapted to be executed to:
interrogate a subject with electromagnetic radiation in a frequency range of about 100 MHz to about 2 THz;
generate, from the interrogating, first digital image data comprising a first D-dimensional array of image elements, where D is an integer, each image element having a respective first value, the first digital image data being representative of at least a first image of at least a portion of the subject;
replace each image element with a set of N image elements each having a same second value to form a second D-dimensional array containing expanded second digital image data, where N is an integer;
perform a computation using the expanded second digital image data as input; and
store a result of the computation in memory.

21. The storage medium of claim 20 wherein the second value of each of the set of N image elements replacing each image element in the first D-dimensional array is equal to the respective first value of the image element the set of N image elements replaces.

22. The storage medium of claim 20 wherein N=n^{D}, where n is an integer greater than 1, and replacing each image element includes replacing each image element with an array of n image elements in each dimension.

23. The storage medium of claim 20 wherein D=2 and each image element is a pixel.

24. The storage medium of claim 23 wherein N is at least 4.

25. The storage medium of claim 20 wherein D=3 and each image element is a voxel.

26. The storage medium of claim 25 wherein N is at least 8.

27. The storage medium of claim 20 wherein performing a computation includes reconstructing a human-viewable image from the expanded second digital image data.
